(19) United States
(12) Patent Application Publication
(10) Pub. No.: US 2026/0193402 A1
(43) Pub. Date: Jul. 9, 2026

(54) ONE-COMPONENT POLYURETHANE-MODIFIED EPOXY RESIN EMULSION, AND PREPARATION METHOD AND USE THEREOF

(71) Applicant: HUBEI BORUI POLYMER MATERIALS CO., LTD., Xiaogan (CN)

(72) Inventor: Wangqing ZHANG, Tianjin (CN)

(73) Assignee: HUBEI BORUI POLYMER MATERIALS CO., LTD., Xiaogan, HB (CN)

(21) Appl. No.: 18/866,790

(22) PCT Filed: May 28, 2024
(86) PCT No.: PCT/CN2024/095628

§ 371 Date: Nov. 18, 2024

(30) Foreign Application Priority Data
Nov. 1, 2023 (CN) 202311434997.7

(51) Int. Cl. C08G 18/48; C08G 18/22; C08G 18/24; C08G 18/32; C08G 18/58; C08G 18/67; C08G 18/75

(52) U.S. Cl. CPC C08G 18/4808; C08G 18/227; C08G 18/242; C08G 18/3228; C08G 18/4825; C08G 18/4833; C08G 18/58; C08G 18/672; C08G 18/755

(57) ABSTRACT

Provided are a one-component polyurethane-modified epoxy resin emulsion, and a preparation method and use thereof. The method includes: mixing an epoxy resin, a monohydroxy acrylate, a dialkyl maleate, a ketone solvent, an aprotic polar solvent, and a polymerization inhibitor to obtain a mixed solution, an epoxy equivalent of the epoxy resin being not less than 300 g/eq; mixing polyethylene glycol, a polyether diol and/or a polyester diol, a diisocyanate, and an organometallic catalyst, and conducting addition polymerization to obtain a polyurethane prepolymer; mixing the mixed solution with the polyurethane prepolymer, conducting addition reaction to obtain a reaction product, adding water to the reaction product and conducting emulsification, and removing the ketone solvent to obtain a waterborne polyurethane epoxy emulsion; and mixing the waterborne polyurethane epoxy emulsion with an alkyl diamine, and subjecting a resulting mixed substance to Michael addition-ring-opening addition reaction to obtain the one-component polyurethane-modified epoxy resin emulsion.

### CROSS-REFERENCE TO RELATED APPLICATIONS

The present application is a national stage application of International Patent Application No. PCT/CN2024/095628, filed on May 28, 2024, which claims priority to Chinese Patent Application CN202311434997.7 filed with the China National Intellectual Property Administration (CNIPA) on Nov. 1, 2023 and entitled “ONE-COMPONENT POLYURETHANE-MODIFIED EPOXY RESIN EMULSION, AND PREPARATION METHOD AND USE THEREOF”, the disclosures of which are incorporated herein by reference in their entireties.

### TECHNICAL FIELD

The present disclosure belongs to the technical field of waterborne epoxy resins, and specifically relates to a one-component polyurethane-modified epoxy resin emulsion, and a preparation method and use thereof.

### BACKGROUND

Waterborne epoxy resins are a class of widely used polymer materials. According to the dissolved state or the dispersed state of the epoxy resins in water, the waterborne epoxy resins can be divided into water-soluble epoxy resins and epoxy resin emulsions, of which the epoxy resin emulsions have attracted much attention due to their characteristics such as low viscosity and convenient for use. However, most commercially available epoxy resin emulsions adopt a low-molecular-weight liquid epoxy resin that appears in a liquid state after the solvent being evaporated.

Therefore, the epoxy resin emulsions are rarely used alone, only when combined with a curing agent to form a solid three-dimensional network structure, do they have a use value. Therefore, there is an urgent need to develop an epoxy resin emulsion that can be directly cured into a film without the addition of an additional curing agent.

### SUMMARY

In view of this, an object of the present disclosure is to provide a one-component polyurethane-modified epoxy resin emulsion, and a preparation method and use thereof. The one-component polyurethane-modified epoxy resin emulsion prepared in the present disclosure can be used as a single component, and can be cured alone into a paint film without an epoxy curing agent.

To achieve the above object, the present disclosure adopts the following technical solutions:

The present disclosure provides a method for preparing a one-component polyurethane-modified epoxy resin emulsion, including:
mixing an epoxy resin, a monohydroxy acrylate, a dialkyl maleate, a ketone solvent, an aprotic polar solvent, and a polymerization inhibitor to obtain a mixed solution, wherein an epoxy equivalent of the epoxy resin is greater than or equal to 300 g/eq;
mixing polyethylene glycol, a polyether diol and/or a polyester diol, a diisocyanate, and an organometallic catalyst to obtain a mixture, and subjecting the mixture to addition polymerization to obtain a polyurethane prepolymer;
mixing the mixed solution with the polyurethane prepolymer to obtain a mixed system, subjecting the mixed system to an addition reaction to obtain a reaction product, adding water to the reaction product and conducting emulsification, and removing the ketone solvent to obtain a waterborne polyurethane epoxy emulsion; and
mixing the waterborne polyurethane epoxy emulsion with an alkyl diamine to obtain a mixed substance, and subjecting the mixed substance to a Michael addition-ring-opening addition reaction to obtain the one-component polyurethane-modified epoxy resin emulsion.

In some embodiments, the monohydroxy acrylate includes one or more selected from the group consisting of hydroxyethyl acrylate, hydroxypropyl acrylate, and hydroxybutyl acrylate;
the dialkyl maleate includes one or more selected from the group consisting of diethyl maleate, dibutyl maleate, and diethylhexyl maleate;
the ketone solvent includes one or more selected from the group consisting of acetone, butanone, and cyclohexanone; and
the polymerization inhibitor includes one or more selected from the group consisting of hydroquinone, tert-butylcatechol, and p-hydroxyanisole.

In some embodiments, a molar ratio of the monohydroxy acrylate to the dialkyl maleate is in a range of 0.5-1:0.5-1;

a mass of the polymerization inhibitor is 0.1% to 1.5% of a mass of the monohydroxy acrylate; and
a mass of the epoxy resin is 80% to 100% of a total mass of the monohydroxy acrylate, the dialkyl maleate, the ketone solvent, and the aprotic polar solvent.

In some embodiments, the polyethylene glycol has a molecular weight of 300 Da to 2,000 Da;
the polyether diol and the polyester diol each independently have a molecular weight of 1,000 Da to 2,000 Da; and the polyether diol includes polypropylene glycol and/or polytetrahydrofuran;
the diisocyanate includes one or more selected from the group consisting of toluene diisocyanate, isophorone diisocyanate, hexamethylene diisocyanate, diphenylmethane diisocyanate, dicyclohexylmethane diisocyanate, and trimethylhexane diisocyanate;
the organometallic catalyst includes an organotin catalyst and/or an organobismuth catalyst;
a molar ratio of a total amount of hydroxyl in the polyether diol and/or the polyester diol and hydroxyl in the polyethylene glycol to isocyanate in the diisocyanate is in a range of 0.2-0.8:1;
a mass of the organometallic catalyst is 0.001% to 0.1% of a mass of the diisocyanate; and
a molar ratio of the isocyanate in the diisocyanate to hydroxyl in the monohydroxy acrylate is in a range of 1:0.3-0.5.

In some embodiments, the addition polymerization is conducted at a temperature of 60° C. to 90° C. for 2 h to 6 h.

In some embodiments, a solid content of the waterborne polyurethane epoxy emulsion is in a range of 30 wt % to 50 wt %; and
the addition reaction is conducted at a temperature of 60° C. to 90° C. for 2 h to 6 h.

In some embodiments, the emulsification is conducted at a temperature of 40° C. to 50° C. for 1 h to 5 h.

In some embodiments, the alkyl diamine includes one or more selected from the group consisting of ethylenediamine, 1,4-butanediamine, and 1,6-hexanediamine;
a molar ratio of a total amount of the monohydroxy acrylate and the dialkyl maleate to the alkyl diamine is 1:1; and
the Michael addition-ring-opening addition reaction is conducted at a temperature of less than or equal to 50° C. for 2 h to 5 h.

The present disclosure provides a one-component polyurethane-modified epoxy resin emulsion prepared by the method described in the above technical solutions.

The present disclosure provides use of the one-component polyurethane-modified epoxy resin emulsion described in the above technical solution in a coating and/or an anti-corrosion material.

In the present disclosure, an epoxy resin, a monohydroxy acrylate, and a dialkyl maleate are mixed to obtain a mixed solution, polyethylene glycol, a polyether diol and/or a polyester diol, and a diisocyanate are subjected to addition polymerization to obtain a polyurethane prepolymer, the monohydroxy acrylate and the diisocyanate are subjected to an addition reaction, and isocyanate in the diisocyanate and secondary hydroxyl in the epoxy resin are subjected to an addition reaction, so as to obtain an acrylate-terminated waterborne polyurethane epoxy emulsion. The waterborne polyurethane is introduced into the epoxy resin through a covalent bond on the one hand, to increase the toughness of the epoxy resin, and on the other hand to allow the self-emulsification of the epoxy resin, such that an acrylate-terminated waterborne polyurethane epoxy emulsion having a core-shell structure with a hydrophilic polyurethane as a shell and the epoxy resin as a core can be formed.

Then, the acrylate terminal group and the dialkyl maleate in the waterborne polyurethane epoxy emulsion each are subjected to a Michael addition reaction with an alkyl diamine, such that the alkyl diamine is converted into an alkyl secondary amine to form a secondary amino-modified waterborne polyurethane epoxy emulsion; subsequently, the secondary amino and the epoxy resin are subjected to a ring-opening addition (chain extension) reaction inside waterborne polyurethane epoxy emulsion particles, to increase the molecular weight of the epoxy resin to obtain the one-component polyurethane-modified epoxy resin emulsion. The one-component polyurethane-modified epoxy resin emulsion can be cured alone to form a paint film without addition of an epoxy curing agent. In addition, since the chain expansion reaction occurs in the core of the emulsion, the one-component polyurethane-modified epoxy resin emulsion has good stability.

### DETAILED DESCRIPTION OF THE EMBODIMENTS

The present disclosure provides a method for preparing a one-component polyurethane-modified epoxy resin emulsion, including:
mixing an epoxy resin, a monohydroxy acrylate, a dialkyl maleate, a ketone solvent, an aprotic polar solvent, and a polymerization inhibitor to obtain a mixed solution, wherein an epoxy equivalent of the epoxy resin is greater than or equal to 300 g/eq;
mixing polyethylene glycol, a polyether diol and/or a polyester diol, a diisocyanate, and an organometallic catalyst to obtain a mixture, and subjecting the mixture to addition polymerization to obtain a polyurethane prepolymer;
mixing the mixed solution with the polyurethane prepolymer to obtain a mixed system, subjecting the mixed system to an addition reaction to obtain a reaction product, adding water to the reaction product and conducting emulsification, and removing the ketone solvent to obtain a waterborne polyurethane epoxy emulsion; and
mixing the waterborne polyurethane epoxy emulsion with an alkyl diamine to obtain a mixed substance, and subjecting the mixed substance to a Michael addition-ring-opening addition reaction to obtain the one-component polyurethane-modified epoxy resin emulsion.

In the present disclosure, unless otherwise specified, all materials and devices used are commercially available products in the art.

In the present disclosure, an epoxy resin, a monohydroxy acrylate, a dialkyl maleate, a ketone solvent, an aprotic polar solvent, and a polymerization inhibitor are mixed to obtain a mixed solution, wherein an epoxy equivalent of the epoxy resin is greater than or equal to 300 g/eq. As used herein, the variable g/eq refers to the epoxy equivalent weight and is defined as the number of grams of epoxy resin required to give 1 mole of epoxy groups.

In some embodiments of the present disclosure, the monohydroxy acrylate includes one or more selected from the group consisting of hydroxyethyl acrylate, hydroxypropyl acrylate, and hydroxybutyl acrylate, and preferably hydroxyethyl acrylate.

In some embodiments of the present disclosure, the dialkyl maleate includes one or more selected from the group consisting of diethyl maleate, dibutyl maleate, and diethylhexyl maleate. In some embodiments of the present disclosure, a molar ratio of the monohydroxy acrylate to the dialkyl maleate is in a range of 0.5-1:0.5-1, preferably 0.6-0.9:0.6-0.9, and more preferably 0.7-0.8:0.7-0.8.

In some embodiments of the present disclosure, the polymerization inhibitor includes one or more selected from the group consisting of hydroquinone, tert-butyl catechol, and p-hydroxyanisole and preferably p-hydroxyanisole. In some embodiments of the present disclosure, a mass of the polymerization inhibitor is 0.1% to 1.5%, preferably 0.5% to 1%, and more preferably 0.6% to 0.8% of a mass of the monohydroxy acrylate.

In some embodiments of present disclosure, the ketone solvent includes one or more selected from the group consisting of acetone, butanone, and cyclohexanone, and preferably acetone.

In some embodiments of present disclosure, the aprotic polar solvent is one or more selected from the group consisting of propylene glycol methyl ether, ethylene glycol monobutyl ether, propylene glycol methyl ether acetate, and ethylene glycol methyl ether acetate, and preferably propylene glycol methyl ether acetate and/or ethylene glycol methyl ether acetate.

In some embodiments of the present disclosure, the epoxy resin includes one or more selected from the group consisting of E31, E20, E12, E09, E06, and E03, and preferably E06 and/or E03. In some embodiments of the present disclosure, a mass of the epoxy resin is 80% to 100%, preferably 85% to 95%, and more preferably 88% to 90% of a total mass of the monohydroxy acrylate, the dialkyl maleate, the ketone solvent, and the aprotic polar solvent.

In some embodiments of the present disclosure, after the mixing, the method further includes heating and refluxing a mixed slurry obtained after the mixing until the epoxy resin is completely dissolved to obtain the mixed solution. In some embodiments of the present disclosure, the heating and refluxing is conducted at a temperature of 30° C. to 90° C., preferably 40° C. to 80° C., and more preferably 50° C. to 60° C. In the present disclosure, the epoxy resin is dissolved in the monohydroxy acrylate and the dialkyl maleate by heating and refluxing to obtain the mixed solution.

In the present disclosure, polyethylene glycol, a polyether diol and/or a polyester diol, a diisocyanate, and an organometallic catalyst are mixed to obtain a mixture, and the mixture is subjected to addition polymerization to obtain a polyurethane prepolymer.

In some embodiments of the present disclosure, the polyethylene glycol has a molecular weight of 300 Da to 2,000 Da, preferably 500 Da to 1,500 Da, and more preferably 550 Da to 1,000 Da.

In some embodiments of the present disclosure, the polyether diol and the polyester diol each independently have a molecular weight of 1,000 Da to 2,000 Da. In some embodiments of the present disclosure, the polyether diol includes polypropylene glycol and/or polytetrahydrofuran, and the polyester diol is a polyester diol prepared based on adipic acid and an alkyl diol.

In some embodiments of the present disclosure, the diisocyanate includes one or more selected from the group consisting of toluene diisocyanate, isophorone diisocyanate, hexamethylene diisocyanate, diphenylmethane diisocyanate, dicyclohexylmethane diisocyanate, and trimethylhexane diisocyanate, and preferably toluene diisocyanate and/or isophorone diisocyanate. In some embodiments of the present disclosure, a molar ratio of a total amount of hydroxyl in the polyether diol and/or the polyester diol and hydroxyl in the polyethylene glycol to isocyanate in the diisocyanate is in a range of 0.2-0.8:1, preferably 0.3-0.7:1, and more preferably 0.4-0.5:1. In some embodiments of the present disclosure, a molar ratio of the isocyanate in the diisocyanate to hydroxyl in the monohydroxy acrylate is in a range of 1:0.3-0.5, and preferably 1:0.4.

In the present disclosure, polyurethane prepolymers having different structures and polarities can be prepared from polyethylene glycols having different molecular weights, polyether diols and/or polyester diols having different structures and molecular weights, and diisocyanates having different structures, and the polarity of the prepared one-component polyurethane-modified epoxy resin emulsion can be adjusted using polyurethane components to adapt to different applications (For example, according to the “similarity and intermiscibility” principle, water is a polar liquid, and if the polyurethane component has a strong polarity, the epoxy resin emulsion is easily-soluble in water when in use, resulting in poor water resistance. Therefore, the low-polarity polyurethane component has excellent water resistance). Therefore, the one-component polyurethane-modified epoxy resin emulsion has a wide adaptation range.

In some embodiments of the present disclosure, the organometallic catalyst includes an organotin catalyst and/or an organobismuth catalyst. In some embodiments of the present disclosure, a mass of the organometallic catalyst is 0.001% to 0.1%, preferably 0.01% to 0.5%, and more preferably 0.04% to 0.1% of a mass of the diisocyanate.

In some embodiments of the present disclosure, the addition polymerization is conducted at a temperature of 60° C. to 90° C., preferably 65° C. to 85° C., and more preferably 75° C. to 80° C., and the addition polymerization is conducted for 2 h to 6 h, preferably 3 h to 5 h, and more preferably 4 h. As used herein, the variable h refers to hours.

In the present disclosure, after obtaining the mixed solution and the polyurethane prepolymer, the mixed solution is mixed with the polyurethane prepolymer, a resulting mixed system is subjected to an addition reaction to obtain a reaction product, water is added to the reaction product and a resulting system is subjected to emulsification, and the ketone solvent is removed to obtain the waterborne polyurethane epoxy emulsion.

In some embodiments of the present disclosure, the addition reaction is conducted at a temperature of 60° C. to 90° C., preferably 65° C. to 85° C., and more preferably 75° C. to 80° C., and the addition reaction is conducted for 2 h to 6 h, preferably 3 h to 5 h, and more preferably 4 h. In the present disclosure, during the addition reaction, the diisocyanate and the monohydroxy acrylate are subjected to an addition reaction, and the isocyanate in the diisocyanate and the secondary hydroxyl in the epoxy resin are subjected to an addition reaction.

There is no specific limitation on the amount of water, as long as the solid content of the waterborne polyurethane epoxy emulsion can reach 30 wt % to 50 wt %. In some embodiments of the present disclosure, a solid content of the waterborne polyurethane epoxy emulsion is in a range of 35 wt % to 45 wt %, and preferably 40 wt % to 43 wt %.

In some embodiments of the present disclosure, the emulsification is conducted at a temperature of preferably 40° C. to 50° C., preferably 42° C. to 48° C., and more preferably 43° C. to 45° C., and the emulsification is conducted for 1 h to 5 h, preferably 2 h to 4 h, and more preferably 3 h.

In some embodiments of the present disclosure, the removing is conducted by vacuum distillation. There is no specific limitation on the conditions of the vacuum distillation, as long as the ketone solvent can be completely removed without destroying other components.

In the present disclosure, the waterborne polyurethane is introduced into the epoxy resin with an epoxy equivalent of greater than or equal to 300 g/eq through a covalent bond, on the one hand, to increase the toughness of the epoxy resin, and on the other hand to allow the self-emulsification of the epoxy resin, such that an acrylate-terminated waterborne polyurethane epoxy emulsion having a core-shell structure with a hydrophilic polyurethane as a shell and the epoxy resin as a core can be formed.

In the present disclosure, after obtaining the waterborne polyurethane epoxy emulsion, the waterborne polyurethane epoxy emulsion is mixed with an alkyl diamine to obtain a mixed substance, and the mixed substance is subjected to a Michael addition-ring-opening addition reaction to obtain the one-component polyurethane-modified epoxy resin emulsion.

In some embodiments of the present disclosure, the alkyl diamine includes one or more selected from the group consisting of ethylenediamine, 1,4-butanediamine, and 1,6-hexanediamine, and preferably ethylenediamine and/or 1,4-butanediamine; and a molar ratio of a total amount of the monohydroxy acrylate and the dialkyl maleate to the alkyl diamine is 1:1. In some embodiments of the present disclosure, the alkyl diamine is used in the form of an alkyl diamine aqueous solution, and a concentration of the alkyl diamine aqueous solution is 50 wt %; an addition mold of the alkyl diamine is conducted by dropwise addition; the dropwise addition is conducted for 1 h to 6 h, preferably 2 h to 5 h, and more preferably 3 h to 4 h, and the dropwise addition is conducted at room temperature under stirring.

In some embodiments of the present disclosure, the Michael addition-ring-opening addition reaction is conducted at a temperature of less than or equal to 50° C., preferably 25° C. to 40° C., and more preferably 30° C. to 35° C., and the Michael addition-ring-opening addition reaction is conducted for 2 h to 5 h, and preferably 3 h to 4 h. In the present disclosure, the Michael addition-ring-opening addition reaction includes a Michael addition reaction and a ring-opening addition reaction. The Michael addition reaction includes a Michael addition reaction between the dialkyl maleate and the alkyl diamine and a Michael addition reaction between an acrylate terminal group and the alkyl diamine. The ring-opening addition reaction refers to a ring-opening addition reaction between secondary amino and an epoxy group in the waterborne polyurethane epoxy emulsion.

In some embodiments of the present disclosure, the Michael addition-ring-opening addition reaction includes a first Michael addition-ring-opening addition reaction and a second Michael addition-ring-opening addition reaction conducted sequentially. In some embodiments of the present disclosure, the first Michael addition-ring-opening addition reaction is conducted at room temperature, and the first Michael addition-ring-opening addition reaction is conducted for 1 h to 2 h, preferably 1.2 h to 1.8 h, and more preferably 1.4 h to 1.6 h; and the second Michael addition-ring-opening addition reaction is conducted at a temperature of 40° C. to 50° C., preferably 42° C. to 48° C., and more preferably 43° C. to 45° C., and the second Michael addition-ring-opening addition reaction is conducted for 1 h to 3 h, preferably 1.5 h to 2.5 h, and more preferably 1.8 h to 2 h.

The present disclosure provides a one-component polyurethane-modified epoxy resin emulsion prepared by the method described in the above technical solutions.

The present disclosure provides use of the one-component polyurethane-modified epoxy resin emulsion described in the above technical solution in a coating and/or an anti-corrosion material.

To further illustrate the present disclosure, the one-component polyurethane-modified epoxy resin emulsion, and the preparation method and use thereof provided in the present disclosure will be described in detail below with reference to examples, but the examples should not be interpreted as limiting the scope of the present disclosure.

In all examples and comparative examples of the present disclosure, the epoxy resins E06, E03, and E20 all were purchased from Jiangsu Sanmu Chemical Co., Ltd.; the polyethylene glycol PEG1000 had a molecular weight of 1,000 Da (Dalton) and was purchased from Shanghai Dongda Chemical Co., Ltd.; the polypropylene glycol DL2000 had a molecular weight of 2,000 Da and was purchased from Shandong Bluestar Dongda Co., Ltd.; and the organobismuth catalyst MC-710 was purchased from Beijing BaiYuan Chemical Co., Ltd.

### Example 1

6,660 g of solid epoxy resin E06, 464 g of hydroxyethyl acrylate, 912 g of dibutyl maleate, 3,300 g of acetone, 2,000 g of propylene glycol methyl ether acetate, and 0.50 g of p-hydroxyanisole were added to a reactor, and heated and refluxed at 70° C. until the solid epoxy resin was completely dissolved to obtain a mixed solution.

2,000 g of polyethylene glycol (PEG1000), 2,000 g of dried polypropylene glycol (DL2000), 0.20 g of organobismuth catalyst (MC-710), and 1,112 g of isophorone diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 17,840 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion (including a mixture of the epoxy resin, the dialkyl maleate, and an acrylate-terminated polyurethane).

Under the conditions of room temperature and stirring, 480 g of an aqueous solution of ethylenediamine with a concentration of 50 wt % was added dropwise to the waterborne polyurethane epoxy emulsion within 2 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a one-component polyurethane-modified epoxy resin emulsion.

### Example 2

6,660 g of solid epoxy resin E06, 464 g of hydroxyethyl acrylate, 1,360 g of diethylhexyl maleate, 2,860 g of acetone, 2,000 g of ethylene glycol methyl ether acetate, and 0.50 g of p-hydroxyanisole were added to a reactor, and heated and refluxed at 70° C. until the solid epoxy resin was completely dissolved to obtain a mixed solution.

2,000 g of polyethylene glycol (PEG1000), 2,000 g of dried polypropylene glycol (DL2000), 0.20 g of organobismuth catalyst (MC-710), and 871 g of toluene diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 18,210 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion.

Under the conditions of room temperature and stirring, 704 g of an aqueous solution of 1,4-butanediamine with a concentration of 50 wt % was added dropwise to the waterborne polyurethane epoxy emulsion within 2 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a one-component polyurethane-modified epoxy resin emulsion.

### Example 3

6,660 g of solid epoxy resin E03, 696 g of hydroxyethyl acrylate, 1,360 g of diethylhexyl maleate, 2,860 g of acetone, 2,000 g of propylene glycol methyl ether acetate, and 0.60 g of p-hydroxyanisole were added to a reactor, and heated and refluxed at 70° C. until the solid epoxy resin was completely dissolved to obtain a mixed solution.

1,500 g of polyethylene glycol (PEG1000), 1,000 g of dried polypropylene glycol (DL2000), 0.20 g of organobismuth catalyst (MC-710), and 1,112 g of isophorone diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 17,710 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion.

Under the conditions of room temperature and stirring, 880 g of an aqueous solution of 1,4-butanediamine with a concentration of 50 wt % was added dropwise to the waterborne polyurethane epoxy emulsion within 2 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a one-component polyurethane-modified epoxy resin emulsion.

### Example 4

6,660 g of solid epoxy resin E03, 696 g of hydroxyethyl acrylate, 1,360 g of diethylhexyl maleate, 2,860 g of acetone, 1,000 g of propylene glycol methyl ether acetate, 1,000 g of ethylene glycol methyl ether acetate, and 0.60 g of p-hydroxyanisole were added to a reactor, and heated and refluxed at 70° C. until the solid epoxy resin was completely dissolved to obtain a mixed solution.

1,500 g of polyethylene glycol (PEG1000), 1,000 g of dried polypropylene glycol (DL2000), 0.20 g of organobismuth catalyst (MC-710), and 1,112 g of isophorone diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 16,570 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion.

Under the conditions of room temperature and stirring, 480 g of an aqueous solution of ethylenediamine with a concentration of 50 wt % was added dropwise to the waterborne polyurethane epoxy emulsion within 4 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a one-component polyurethane-modified epoxy resin emulsion.

### Example 5

6,660 g of solid epoxy resin E20, 464 g of hydroxyethyl acrylate, 1,376 g of diethyl maleate, 3,300 g of acetone, 2,000 g of propylene glycol methyl ether acetate, and 0.50 g of p-hydroxyanisole were added to a reactor, and heated and refluxed at 70° C. until the solid epoxy resin was completely dissolved to obtain a mixed solution.

2,000 g of polyethylene glycol (PEG1000), 2,000 g of dried polypropylene glycol (DL2000), 0.20 g of organobismuth catalyst (MC-710), 667 g of isophorone diisocyanate, and 349 g of toluene diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 16,570 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion.

Under the conditions of room temperature and stirring, 880 g of an aqueous solution of 1,4-butanediamine with a concentration of 50 wt % was added dropwise to the waterborne polyurethane epoxy emulsion within 2 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a single-component polyurethane-modified epoxy resin emulsion.

### Comparative Example 1

6,660 g of solid epoxy resin E06, 912 g of dibutyl maleate, 3,300 g of acetone, 2,000 g of propylene glycol methyl ether acetate, and 0.50 g of p-hydroxyanisole were added to a reactor, and heated and refluxed at 70° C. until the solid epoxy resin was completely dissolved to obtain a mixed solution.

2,000 g of polyethylene glycol (PEG1000), 2,000 g of dried polypropylene glycol (DL2000), 0.20 g of organobismuth catalyst (MC-710), and 1,112 g of isophorone diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 19,145 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion.

Under the conditions of room temperature and stirring, 480 g of an aqueous solution of ethylenediamine with a concentration of 50 wt % was added dropwise to the waterborne polyurethane epoxy emulsion within 2 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a one-component polyurethane-modified epoxy resin emulsion.

### Comparative Example 2

6,660 g of solid epoxy resin E06, 464 g of hydroxyethyl acrylate, 3,300 g of acetone, 2,000 g of propylene glycol methyl ether acetate, and 0.50 g of p-hydroxyanisole were added to a reactor, and heated and refluxed at 70° C. until the solid epoxy resin was completely dissolved to obtain a mixed solution.

2,000 g of polyethylene glycol (PEG1000), 2,000 g of dried polypropylene glycol (DL2000), 0.20 g of organobismuth catalyst (MC-710), and 1,112 g of isophorone diisocyanate were added to a reactor, stirred to be uniform, and heated to 75° C. and subjected to reaction for 4 h to obtain a polyurethane prepolymer.

The mixed solution was added to the reactor having the polyurethane prepolymer, and a resulting system was subjected to reflux reaction at 70° C. for 3 h, and cooled to 40° C. 18,470 g of water was added thereto to obtain an intermediate solution. The intermediate solution was stirred at 40° C. for 3 h, subjected to reduced pressure distillation to remove acetone, and cooled to room temperature to obtain a waterborne polyurethane epoxy emulsion.

Under the conditions of room temperature and stirring, 480 g of an aqueous solution of ethylenediamine with a concentration of 50 wt % was added dropwise to the waterborne polyurethane epoxy emulsion within 2 h. After the dropwise addition was completed, a resulting mixture was subjected to reaction for 2 h to obtain an intermediate solution. The intermediate solution was heated to 50° C., and subjected to reaction for 2 h, and a resulting product was cooled to room temperature to obtain a one-component polyurethane-modified epoxy resin emulsion.

### Test Example 1

Table 1 shows basic parameters of the one-component polyurethane-modified epoxy resin emulsions prepared in Examples 1 to 5 and Comparative Examples 1 and 2. The appearance, solid content, pH value, viscosity, particle size, thermal storage stability, freeze-thaw stability, centrifugal stability, and dilution stability were tested with reference to GB/T 11175-2021. An emulsion particle size testing instrument was Zetasizer Nano ZS, and an emulsion was diluted with water to 1 wt % for testing. A viscosity testing instrument was a Brookfield viscometer DV1, and a viscosity was directly tested at 25° C. Epoxy value: An epoxy value of an emulsion was determined by the hydrochloric acid-acetone method in the national standard GB-T1677-2008. Volatile organic compounds: Volatile organic compounds were tested with reference to GB/T 23986-2009. Storage stability: An emulsion was allowed to stand at a temperature of 15° C. to 30° C., and whether a precipitate occurred was observed. Centrifugal stability: 30 mL of an emulsion was taken and centrifuged in a centrifuge at 3,000 r/min for 30 min to test the centrifugal stability of the emulsion. Thermal storage stability: 100 mL of an emulsion was heated at 50° C. for 12 h, then cooled to room temperature, and stored at room temperature for 12 h. The above operation was repeated, and whether a precipitate occurred was observed. Freeze-thaw stability: 50 mL of an emulsion was taken, placed in a −5±2° C. cryogenic chamber for 18 h, then taken out, and placed at 23±2° C. for 6 h. The above operation was repeated, and whether a precipitate occurred was observed. Dilution stability: 10 mL of an emulsion was taken, diluted to a solid content of 2 wt % to 3 wt %, and allowed to stand at room temperature for 48 h, and whether a precipitate occurred was observed.

TABLE 1
Basic parameters of the one-component polyurethane-modified epoxy resin
emulsions prepared in Examples 1 to 5 and Comparative Examples 1 and 2

| | | | | | | Comparative | Comparative |
|---|---|---|---|---|---|---|---|
| Performance indexes | Example 1 | Example 2 | Example 3 | Example 4 | Example 5 | Example 1 | Example 2 |
| Appearance | White | White | White | White | White | White | White |
| | emulsion | emulsion | emulsion | emulsion | emulsion | emulsion | emulsion |
| Solid content (wt %) | 40% | 40% | 40% | 40% | 40% | 40% | 40% |
| pH | 7.3 | 7.3 | 7.6 | 7.6 | 7.6 | 8.0 | 8.0 |
| Viscosity (25° C. mPa · s) | 220 | 220 | 260 | 320 | 320 | 320 | 180 |
| Particle size (nm) | 320 | 300 | 320 | 320 | 320 | 660 | 520 |
| Storage stability (d) | >180 | >180 | >180 | >180 | >180 | <60 | <120 |
| Thermal storage stability (times) | 6 | 6 | 6 | 6 | 6 | 1 | 3 |
| Freeze-thaw stability (times) | 5 | 5 | 5 | 5 | 5 | 1 | 3 |
| Centrifugal stability (times) | 5 | 5 | 5 | 5 | 5 | 1 | 1 |
| Dilution stability | Milky blue | Milky blue | Milky blue | Milky blue | Milky blue | Unstable | Basically |
| | emulsion | emulsion | emulsion | emulsion | emulsion | | stable |
| Volatile organic compounds (wt %) | 0.1% | 0.1% | 0.1% | 0.1% | 0.1% | 0.1% | 0.1% |

It can be seen from Table 1 that the one-component polyurethane-modified epoxy resin emulsions prepared by the present disclosure have a small particle size and excellent stability, while the one-component polyurethane-modified epoxy resin emulsions prepared in Comparative Examples 1 and 2 have a large particle size and poor stability.

### Test Example 2

The one-component polyurethane-modified epoxy resin emulsions prepared in Examples 1 to 5 and Comparative Examples 1 and 2 each were sprayed on a surface of a steel plate, dried at room temperature for 30 man, dried at 90° C. for 5 m, dried at 180° C. for 5 mi, and then tested for paint film performance (paint film thickness: 55 μm to 60 μm). Test results are shown in Table 2. The tests were conducted according to the following test methods or standards: Paint film pencil hardness: GB/T 6739-2006. Paint film flexibility: GB/T 1731-2020. Cross-cut test for adhesion: GB/T 9286-2021. Wet film adhesion: a test plate was soaked in distilled water at 25° C. for 144 h, wipe-dried, and tested by a cross-cut test for adhesion. Salt spray resistance: GB/T 1771-2007.

TABLE 2
Test results of paint film performance

| | | | | | Wet film | Salt spray |
|---|---|---|---|---|---|---|
| | Film appearance | Hardness | Flexibility | Adhesion | adhesion | resistance |
| Example 1 | Smooth and transparent | 2H | <1 mm | Grade 0 | Grade 1 | 800 h |
| Example 2 | Smooth and transparent | 2H | <1 mm | Grade 0 | Grade 1 | 800 h |
| Example 3 | Smooth and transparent | 2H | <1 mm | Grade 0 | Grade 1 | 800 h |
| Example 4 | Smooth and transparent | 2H | <1 mm | Grade 0 | Grade 1 | 900 h |
| Example 5 | Smooth and transparent | 2H | <1 mm | Grade 0 | Grade 1 | 900 h |
| Comparative Example 1 | Grainy | 1H | <1 mm | Grade 3 | Grade 7 | 100 h |
| Comparative Example 2 | Grainy | 1H | <1 mm | Grade 2 | Grade 6 | 100 h |

It can be seen from Table 2 that the one-component polyurethane-modified epoxy resin emulsions prepared by the present disclosure can be directly dried and cured into paint films without the addition of a curing agent, having an appropriate hardness, excellent flexibility, outstanding adhesion, and excellent salt spray resistance, while the paint films prepared from Comparative Examples 1 and 2 have a grainy surface, a low hardness, and poor adhesion and salt spray resistance.

Although the present disclosure has been described in detail through the above examples, the examples are merely some rather than all of the examples of the present disclosure. All other examples obtained by a person based on these examples without creative efforts shall fall within the scope of the present disclosure.

1. A method for preparing a one-component polyurethane-modified epoxy resin emulsion, comprising:
mixing an epoxy resin, a monohydroxy acrylate, a dialkyl maleate, a ketone solvent, an aprotic polar solvent, and a polymerization inhibitor to obtain a mixed solution, wherein an epoxy equivalent of the epoxy resin is greater than or equal to 300 g/eq;
mixing polyethylene glycol, a polyether diol and/or a polyester diol, a diisocyanate, and an organometallic catalyst to obtain a mixture, and subjecting the mixture to addition polymerization to obtain a polyurethane prepolymer;
mixing the mixed solution with the polyurethane prepolymer to obtain a mixed system, subjecting the mixed system to an addition reaction to obtain a reaction product, adding water to the reaction product and conducting emulsification, and removing the ketone solvent to obtain a waterborne polyurethane epoxy emulsion; and
mixing the waterborne polyurethane epoxy emulsion with an alkyl diamine to obtain a mixed substance, and subjecting the mixed substance to a Michael addition-ring-opening addition reaction to obtain the one-component polyurethane-modified epoxy resin emulsion.

2. The method of claim 1, wherein the monohydroxy acrylate comprises one or more selected from the group consisting of hydroxyethyl acrylate, hydroxypropyl acrylate, and hydroxybutyl acrylate;
the dialkyl maleate comprises one or more selected from the group consisting of diethyl maleate, dibutyl maleate, and diethylhexyl maleate;
the ketone solvent comprises one or more selected from the group consisting of acetone, butanone, and cyclohexanone; and
the polymerization inhibitor comprises one or more selected from the group consisting of hydroquinone, tert-butylcatechol, and p-hydroxyanisole.

3. The method of claim 1, wherein a molar ratio of the monohydroxy acrylate to the dialkyl maleate is in a range of 0.5-1:0.5-1;
a mass of the polymerization inhibitor is 0.1% to 1.5% of a mass of the monohydroxy acrylate; and
a mass of the epoxy resin is 80% to 100% of a total mass of the monohydroxy acrylate, the dialkyl maleate, the ketone solvent and the aprotic polar solvent.

4. The method of claim 1, wherein the aprotic polar solvent is one or more selected from the group consisting of propylene glycol methyl ether, ethylene glycol monobutyl ether, propylene glycol methyl ether acetate, and ethylene glycol methyl ether acetate.

5. The method of claim 1, wherein the polyethylene glycol has a molecular weight of 300 Da to 2,000 Da;
the polyether diol and the polyester diol each independently have a molecular weight of 1,000 Da to 2,000 Da; and the polyether diol comprises polypropylene glycol and/or polytetrahydrofuran;
the diisocyanate comprises one or more selected from the group consisting of toluene diisocyanate, isophorone diisocyanate, hexamethylene diisocyanate, diphenylmethane diisocyanate, dicyclohexylmethane diisocyanate, and trimethylhexane diisocyanate;
the organometallic catalyst comprises an organotin catalyst and/or an organobismuth catalyst;
a molar ratio of a total amount of hydroxyl in the polyether diol and/or the polyester diol and hydroxyl in the polyethylene glycol to isocyanate in the diisocyanate is in a range of 0.2-0.8:1;
a mass of the organometallic catalyst is 0.001% to 0.1% of a mass of the diisocyanate; and
a molar ratio of the isocyanate in the diisocyanate to hydroxyl in the monohydroxy acrylate is in a range of 1:0.3-0.5.

6. The method of claim 1, wherein the polyester diol is prepared from adipic acid and an alkyl diol.

7. The method of claim 1, wherein the addition polymerization is conducted at a temperature of 60° C. to 90° C. for 2 h to 6 h.

8. The method of claim 1, wherein a solid content of the waterborne polyurethane epoxy emulsion is in a range of 30 wt % to 50 wt %; and
the addition reaction is conducted at a temperature of 60° C. to 90° C. for 2 h to 6 h.

9. The method of claim 1, wherein the emulsification is conducted at a temperature of 40° C. to 50° C. for 1 h to 5 h.

10. The method of claim 1, wherein the alkyl diamine comprises one or more selected from the group consisting of ethylenediamine, 1,4-butanediamine, and 1,6-hexanediamine;
a molar ratio of a total amount of the monohydroxy acrylate and the dialkyl maleate to the alkyl diamine is 1:1; and
the Michael addition-ring-opening addition reaction is conducted at a temperature of less than or equal to 50° C. for 2 h to 5 h.

11. The method of claim 1, wherein the Michael addition-ring-opening addition reaction comprises a first Michael addition-ring-opening addition reaction and a second Michael addition-ring-opening addition reaction conducted sequentially;
the first Michael addition-ring-opening addition reaction is conducted at room temperature for 1 h to 2 h; and
the second Michael addition-ring-opening addition reaction is conducted at a temperature of 40° C. to 50° C. for 1 h to 3 h.

12. A one-component polyurethane-modified epoxy resin emulsion prepared by the method of claim 1.

13. (canceled)

14. The method of claim 2, wherein a molar ratio of the monohydroxy acrylate to the dialkyl maleate is in a range of 0.5-1:0.5-1;
a mass of the polymerization inhibitor is 0.1% to 1.5% of a mass of the monohydroxy acrylate; and
a mass of the epoxy resin is 80% to 100% of a total mass of the monohydroxy acrylate, the dialkyl maleate, the ketone solvent, and the aprotic polar solvent.

15. The method of claim 5, wherein the polyester diol is prepared from adipic acid and an alkyl diol.

16. The method of claim 5, wherein the addition polymerization is conducted at a temperature of 60° C. to 90° C. for 2 h to 6 h.

17. The method of claim 8, wherein the emulsification is conducted at a temperature of 40° C. to 50° C. for 1 h to 5 h.

18. The method of claim 10, wherein the Michael addition-ring-opening addition reaction comprises a first Michael addition-ring-opening addition reaction and a second Michael addition-ring-opening addition reaction conducted sequentially;
the first Michael addition-ring-opening addition reaction is conducted at room temperature for 1 h to 2 h; and
the second Michael addition-ring-opening addition reaction is conducted at a temperature of 40° C. to 50° C. for 1 h to 3 h.
